(19) United States
(12) Patent Application Publication
(10) Pub. No.: US 2025/0312222 A1
(43) Pub. Date: Oct. 9, 2025

(54) MEDICAL WORKBENCH, DENTAL OPERATION DEVICE, METHOD FOR CONTROLLING MEDICAL WORKBENCH

(71) Applicant: Guangdong JINME Medical Technology Co., Ltd., Foshan (CN)

(72) Inventors: Xihua CAO, Foshan (CN); Huajun LI, Foshan (CN); Hua WANG, Foshan (CN); Chongyi XU, Foshan (CN); Zihao CHEN, Foshan (CN)

(73) Assignee: Guangdong JINME Medical Technology Co., Ltd., Foshan (CN)

(21) Appl. No.: 19/012,815

(22) Filed: Jan. 7, 2025

(30) Foreign Application Priority Data
Apr. 9, 2024 (CN) 202410422229.8
Apr. 9, 2024 (CN) 202410422231.5

(51) Int. Cl. A61G 15/16

(52) U.S. Cl. CPC A61G 15/16

(57) ABSTRACT

Disclosed are a medical workbench, a dental operation device, and a method for controlling the medical workbench, relating to the technical field of dental implant and tooth protection. The medical workbench includes a gas container, a workbench body and a control device. Each hanging portion at the medical workbench is provided with a hanging state detector.

### CROSS-REFERENCE TO RELATED APPLICATIONS

The present application claims priority to Chinese Patent Application No. 202410422231.5, filed on Apr. 9, 2024, and Chinese Patent Application No. 202410422229.8, filed on Apr. 9, 2024. All of the aforementioned applications are incorporated herein by reference in their entireties.

### TECHNICAL FIELD

The present application relates to the technical field of dental implant and tooth protection, and in particular to a medical workbench, a dental operation device and a method for controlling the medical workbench.

### BACKGROUND

After long-term use, human teeth may be damaged or even fall out, and sometimes dental implants are needed. Dental implants include the process of implanting teeth. In this process, materials such as pure titanium that are highly compatible with human bone will be designed into a cylindrical shape similar to the root of a tooth, and then these cylindrical structures will be implanted into the alveolar bone through dental surgery to form an artificial tooth root. Then a tooth crown will be made at the artificial tooth root.

During the process of dental implants, a medical workbench is used for providing power or cleaning. During the process of dental implants, since the normal saline, gas and other substances in the medical workbench need to enter the human mouth, the sterility level of the medical workbench needs to be further improved.

### SUMMARY

The main purpose of the present application is to provide a medical workbench, aiming to improve the sterility level.

To achieve the above purpose, the medical workbench provided in the present application includes: a gas container; a workbench body; and a control device. The gas container is connected to the workbench body and is configured to accommodate compressed gas; the workbench body is provided with at least two hanging portions, and an output terminal is configured to be hung at one hanging portion; each hanging portion is provided with a hanging state detector, and the hanging state detector is configured to detect whether the output terminal is far away from the hanging portion; the workbench body is further provided with a gas pipe set and a gas valve assembly connected in series in the gas pipe set; one end of the gas pipe set is connected to the gas container, and the other end of the gas pipe set is connected to the output terminal; the hanging state detector is electrically connected to a signal input end of the control device, and a controllable end of the gas valve assembly is electrically connected to a signal output end of the control device; and the control device is configured to establish a gas discharge channel between the output terminal far away from the hanging portion and the gas container according to a detection signal of the hanging state detector and a gas valve on-off signal, to output the compressed gas to outside.

In an embodiment, the gas pipe set includes a main gas pipe and at least two branch gas pipes; one end of the main gas pipe is communicated with the gas container, and the other end of the main gas pipe is communicated with the branch gas pipe; the branch gas pipe is communicated with the output terminal in a one-to-one correspondence.

In an embodiment, the output terminal includes a three-way gun and a sandblasting gun; the gas pipe set is provided with a gas branch connector, and the gas valve assembly includes a gas channel on-off valve; one end of the main gas pipe is communicated with the gas container, and the other end of the main gas pipe is communicated with two branch gas pipes through the gas branch connector; one branch gas pipe is connected to the three-way gun, and the other branch gas pipe is connected to the sandblasting gun; the gas channel on-off valve is connected in series to the branch gas pipe of the sandblasting gun; the control device stores a preset disconnection signal for disconnecting the gas channel on-off valve, and the control device is further configured to use the preset disconnection signal as the gas valve on-off signal in response to that the three-way gun is away from the hanging portion, to form the gas discharge channel between the three-way gun and the gas container according to the preset disconnection signal; and the gas channel on-off valve is electrically connected to the signal output end of the control device, and the control device is further configured to receive a gas discharge start signal configured to turn on the gas channel on-off valve as the gas valve on-off signal in response to that the sandblasting gun is away from the hanging portion, to form the gas discharge channel between the sandblasting gun and the gas container according to the gas discharge start signal.

In an embodiment, the gas pipe set is provided with a gas pressure detector and a pressure regulation valve; the gas pressure detector is configured to detect a gas pressure in the gas pipe set, and the pressure regulation valve is configured to regulate a downstream gas pressure of the gas pipe set; the gas pressure detector is electrically connected to the signal input end of the control device, and the signal output end of the control device is electrically connected to a controllable end of the pressure regulation valve; the control device is configured to make the pressure regulation valve adjust the downstream gas pressure of the gas pipe set according to a gas pressure detection value of the gas pressure detector; and the gas pressure detector is configured to detect a gas pressure in the main gas pipe, and the pressure regulation valve is connected in series to the main gas pipe to adjust a downstream gas pressure of the main gas pipe.

In an embodiment, the medical workbench further includes a gas compressor and a liquid container. A compressed gas output end of the gas compressor is connected to a gas inlet end of the gas container; the liquid container is connected to the workbench body, and the liquid container is configured to accommodate dental liquid; the workbench body is further provided with a liquid pipe set and a liquid valve assembly connected in series in the liquid pipe set; one end of the liquid pipe set is communicated with the liquid container, and the other end of the liquid pipe set is communicated with the output terminal; the liquid pipe set is connected to a pump assembly; the control device is further configured to receive a liquid discharge start signal input by a user; a controllable end of the liquid valve assembly is electrically connected to the signal output end of the control device, and a controllable end of the pump assembly is electrically connected to the signal output end of the control device; the control device is further configured to establish a liquid discharge channel between an output terminal and the liquid container through the liquid valve assembly and the liquid pipe set in response to that the hanging state detector detects that the output terminal is away from the hanging portion; and the control device is further configured to start the pump assembly and deliver the dental liquid in an established liquid discharge channel in response to receiving the liquid discharge start signal.

In an embodiment, the control device includes a circuit board and an executive device mounted at the circuit board; the liquid container, the circuit board, the gas container and the gas compressor are arranged at the workbench body from up to down; the workbench body includes a workbench shell; the liquid container is mounted at an upper end of an outer side of the workbench shell, and the circuit board, the gas container and the gas compressor are arranged in the workbench shell; and a partition plate is provided in the workbench shell, and the circuit board is mounted at an upper side of the partition plate; the gas container is mounted at a lower side of the partition plate, and the gas compressor is mounted at a bottom end of an inner side of the workbench shell.

In an embodiment, the workbench body is provided with an information output device, and the information output device is electrically connected to the signal output end of the control device; and the control device is further configured to make the information output device output a first preset prompt message and/or make the pump assembly stop pumping dental liquid in response to that at least two of the hanging state detectors detect that the corresponding output terminal is away from the hanging portion.

In an embodiment, the workbench body is provided with a plurality of preset marks; the preset marks correspond to the hanging portion one by one, and the preset marks corresponding to different hanging portions include different preset forms.

In an embodiment, the liquid pipe set includes a main pipe and at least two branch pipes; one end of the main pipe is communicated with the liquid container, and the other end of the main pipe is communicated with the branch pipe; the pump assembly is connected to the main pipe.

In an embodiment, the workbench body is further provided with an adjustment device, and the adjustment device is electrically connected to the signal input end of the control device; the adjustment device is configured to receive an adjustment signal input by a user, and the pump assembly is configured to adjust a rotation speed according to the adjustment signal; and the adjustment device is configured to start and receive the adjustment signal in response to that the control device receives the liquid discharge start signal.

In an embodiment, the pump assembly includes a peristaltic pump and a serial pump, and the output terminal includes a power connector; the liquid pipe set includes two parallel main pipes; one main pipe is connected in series with the serial pump, and the other main pipe is configured to connect to the power connector; the peristaltic pump is arranged in cooperation with the main pipe connected to the power connector, to make the main pipe transport the dental liquid.

In an embodiment, a detachable connector is serially connected to the main pipe connected to the power connector, and the detachable connector is arranged at an upstream end of the peristaltic pump in a liquid delivery direction; and/or the liquid pipe set is provided with a first distribution connector and a second distribution connector; the valve assembly includes a distribution valve, and the liquid pipe set further includes a common pipe; one end of the common pipe is communicated with the liquid container, and the other end of the common pipe is connected to two main pipes through the first distribution connector; two branch pipes are connected to the main pipe serially connected to the serial pump through the second distribution connector, and at least one branch pipe is connected to two branch sub-pipes through the distribution valve; the distribution valve is configured as a three-position two-way solenoid valve including a cut-off position and two conduction positions; the distribution valve is electrically connected to the signal output end of the control device, and the control device is further configured to control each conduction position of the distribution valve according to an output signal of the hanging state detector and control the peristaltic pump to start and stop and the serial pump to start and stop according to the liquid discharge start signal, to form the liquid discharge channel between each output terminal and the liquid container.

In an embodiment, the pump assembly is configured as an electric pump, and the workbench body is further provided with a current detector and an information output device; the current detector is configured to detect a driving current of the pump assembly; the signal output end of the current detector is electrically connected to the control device, and the signal output end of the control device is electrically connected to the information output device; in response to that a detection value of the current detector is greater than or equal to a preset upper limit value or the detection value of the current detector is less than or equal to a preset lower limit value, the control device is further configured to make the information output device output a second preset prompt message and/or make the pump assembly stop pumping the dental liquid; and/or an accommodation groove is provided at a top of the workbench body; part of the liquid container is accommodated in the accommodation groove, and the liquid container is detachably connected to the workbench body; a grip boss is provided at an outer side of the liquid container, and a height gap is formed between the grip boss and the top of the accommodation groove; and/or the medical workbench further includes a start device, and the start device includes a foot pedal device separately arranged with the output terminal and/or the start device includes a switch assembly provided at the output terminal; for at least one of the output terminals, the control device is configured to receive the liquid discharge start signal input by a user through the foot pedal device or through the switch assembly.

The present application further provides a dental operation device including: an output terminal; and the medical workbench as mentioned above. The output terminal includes at least two of a power connector, a three-way gun, an ultrasonic tooth cleaner and a sandblasting gun.

The present application further provides a dental operation device including an output terminal and the medical workbench as mentioned above. The output terminal includes a three-way gun, and the medical workbench further includes a start device; the start device includes a switch assembly provided at the three-way gun; the switch assembly includes a gas channel switch and a liquid channel switch; the gas channel switch is configured to cause the gas discharge channel corresponding to the three-way gun to be connected to an outside world or closed with the outside world, and the liquid channel switch is configured to cause the liquid discharge channel corresponding to the three-way gun to be connected to the outside world or closed with the outside world; the liquid channel switch is provided with a signal output end electrically connected to the controllable end of the pump assembly; and in response to that the hanging state detector detects that the three-way gun is away from the hanging portion, the control device is configured to establish a gas discharge channel between the three-way gun and the gas container through the gas channel switch, or receive the liquid discharge start signal input by a user through the liquid channel switch.

In an embodiment, the output terminal includes a sandblasting gun, and the start device includes a foot pedal device separately arranged with the output terminal; a gas channel on-off valve is connected in series in the gas discharge channel corresponding to the sandblasting gun, and a liquid channel on-off valve is connected in series in the liquid discharge channel corresponding to the sandblasting gun; in response to that the hanging state detector detects that the sandblasting gun is away from the hanging portion, the control device is configured to receive the gas valve on-off signal or the liquid discharge start signal input by the user through the foot pedal device; the liquid pipe set includes a main pipe and at least two branch pipes; one end of the main pipe is communicated with the liquid container, and the other end of the main pipe is communicated with the branch pipe; the pump assembly is connected to the main pipe; the pump assembly includes a peristaltic pump and a serial pump, and the output terminal further includes a power connector; the liquid pipe set includes two parallel main pipes; the serial pump is connected in series to one main pipe, and the power connector is connected to the other main pipe; the peristaltic pump is arranged in cooperation with the main pipe connected to the power connector, to make the main pipe transport dental liquid; the liquid pipe set is provided with a first distribution connector and a second distribution connector; the liquid valve assembly includes a distribution valve, and the liquid pipe set further includes a common pipe; one end of the common pipe is communicated with the liquid container, and the other end of the common pipe is connected to the two main pipes through the first distribution connector; the two branch pipes are connected to the main pipe connected in series with the serial pump through the second distribution connector, and at least one branch pipe is connected to two branch sub-pipes through the distribution valve; the distribution valve is configured as a three-position two-way solenoid valve including a cut-off position and two conduction positions, and the distribution valve is electrically connected to the signal output end of the control device; the control device is further configured to control a conduction position of the distribution valve according to the output signal of the hanging state detector and control the peristaltic pump to start and stop and the serial pump to start and stop according to the liquid discharge start signal, to make the liquid discharge channel formed between each output terminal and the liquid container; the liquid channel on-off valve is configured as the distribution valve, and the output terminal further includes an ultrasonic tooth cleaner; the ultrasonic tooth cleaner and the sandblasting gun are connected to the two branch sub-pipes one by one; in response to that the hanging state detector detects that the ultrasonic tooth cleaner is away from the hanging portion, the control device is further configured to receive the liquid discharge start signal input by the user through the foot pedal; and in response to that the hanging state detector detects that the power connector is away from the hanging portion, the control device is further configured to receive the liquid discharge start signal input by the user through the foot pedal.

The present application further provides a method for controlling a medical workbench, applied to the medical workbench as mentioned above. The method includes: detecting whether the output terminal is away from the hanging portion; and according to information that the output terminal is away from the hanging portion and the gas valve on-off signal, a gas discharge channel is established between the output terminal away from the hanging portion and the gas container, to output compressed gas to outside.

In the technical solutions of the present application, a medical workbench includes a gas container, a workbench body and a control device. Each hanging portion at the medical workbench is provided with a hanging state detector, and the hanging state detector is used to detect whether an output terminal is away from the hanging portion. Compared with connecting the gas pipe set to the pipeline gas, by setting the gas container, the foreign matter in the medical workbench of the present application, such as debris brought into the pipeline gas, can be reduced, and the compressed gas in the gas container is more convenient to discharge and replace, which is beneficial to improve sterility of the medical workbench. The control device is configured to establish a gas discharge channel between the output terminal away from the hanging portion and the gas container according to the detection signal of the hanging state detector and the gas valve on-off signal, so as to output compressed gas to the outside. The medical workbench can simultaneously reduce the conduction time corresponding to the gas discharge channel through the hanging state detector and the gas container, thereby improving the discharge efficiency of the compressed gas, reducing the risk of other foreign matter brought into the compressed gas during the flow process, which is conducive to improving the sterility of the medical workbench, and facilitating the rapid use and outdoor use of the medical workbench.

### BRIEF DESCRIPTION OF THE DRAWINGS

To more clearly illustrate technical solutions in the embodiments of the present application or in the related art, the following will briefly introduce the drawings that need to be used in the description of the embodiments or the related art. Obviously, the drawings in the following description are only some embodiments of the present application. For those skilled in the art, without creative effort, other drawings can be obtained according to the structures shown in these drawings.

FIG. 1 is a three-dimensional structural schematic diagram of a dental operation device according to an embodiment of the present application.

FIG. 2 is a partial structural schematic diagram of the dental operation device according to an embodiment of the present application.

FIG. 3 is a schematic diagram showing connection of a gas pipe set according to an embodiment of the present application.

FIG. 4 is a partial explosion schematic diagram of the dental operation device according to an embodiment of the present application.

FIG. 5 is a partial structural schematic diagram of a medical workbench according to an embodiment of the present application.

FIG. 6 is a schematic diagram showing connection of a liquid pipe set according to an embodiment of the present application.

FIG. 7 is a flow chart of a method for controlling a medical workbench according to an embodiment of the present application.

FIG. 8 is a flow chart of the method for controlling a medical workbench according to another embodiment of the present application.

The realization of the objective, functional characteristics, and advantages of the present application are further described with reference to the accompanying drawings.

### DETAILED DESCRIPTION OF THE EMBODIMENTS

The technical solutions of the embodiments of the present application will be described in detail below with reference to the accompanying drawings. It is obvious that the embodiments described are only some rather than all of the embodiments of the present application. All other embodiments obtained by those skilled in the art based on the embodiments of the present application without creative efforts shall fall within the claimed scope of the present application.

It should be noted that all the directional indications (such as up, down, left, right, front, rear . . . ) in the embodiments of the present application are only used to explain the relative positional relationship, movement, or the like of the components in a certain posture. If the specific posture changes, the directional indication will change accordingly.

Besides, the descriptions associated with, e.g., “first” and “second,” in the present application are merely for descriptive purposes, and cannot be understood as indicating or suggesting relative importance or impliedly indicating the number of the indicated technical feature. Therefore, the feature associated with “first” or “second” can expressly or impliedly include at least one such feature. Further, if “and/or” appears throughout the text, it includes three parallel schemes. Taking “A and/or B” as an example, it includes the scheme A, or the scheme B, or the scheme that the scheme A and the scheme B satisfy at the same time. In addition, the technical solutions of the various embodiments can be combined with each other, but the combinations must be based on the realization of those skilled in the art. When the combination of technical solutions is contradictory or cannot be achieved, it should be considered that such a combination of technical solutions does not exist, nor does it fall within the scope of the present application.

After long-term use, human teeth may be damaged or even fall out, and sometimes dental implants are needed. Dental implants include the process of implanting teeth. In this process, materials such as pure titanium that are highly compatible with human bone will be designed into a cylindrical shape similar to the root of a tooth, and then these cylindrical structures will be implanted into the alveolar bone through dental surgery to form an artificial tooth root. Then a tooth crown will be made at the artificial tooth root.

During the process of dental implants, a medical workbench is used for providing power or cleaning. During the process of dental implants, since the normal saline, gas and other substances in the medical workbench need to enter the human mouth, the sterility level of the medical workbench needs to be further improved.

The present application proposes a medical workbench, which is intended to improve sterility level.

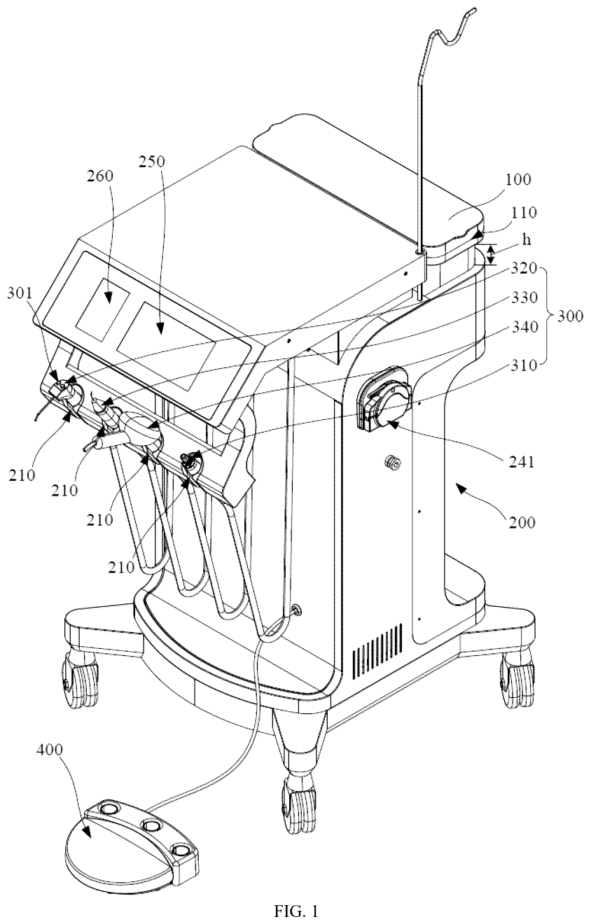

As shown in FIG. 1 to FIG. 6, in an embodiment of the present application, the medical workbench includes a gas container 500, a workbench body 200 and a control device. The gas container 500 is connected to the workbench body 200. The gas container 500 is configured to accommodate compressed gas. The gas container 500 can be configured as a gas storage tank, and the like. The workbench body 200 is provided with at least two hanging portions 210, and the hanging portions 210 are configured to hang output terminals 300, and at least two output terminals 300 can be hung at the workbench body 200. As shown in FIG. 1, a hanger can be provided at the workbench body 200, and the hanging portion 210 can be hung at the hanger. The structure of the hanging portion 210 can be a notch, a groove or a hook. The output terminal 300 can be a terminal structure that can ultimately transport the dental liquid outward. For example, the output terminal 300 can be a dental mobile phone. In an embodiment, the output terminal 300 can include a power connector 310, a three-way gun 320, an ultrasonic tooth cleaner 330, a sandblasting gun 340, and the like. The power connector 310, the three-way gun 320, the ultrasonic tooth cleaner 330 and the sandblasting gun 340 are common structures in the dental field, which will not be repeated here.

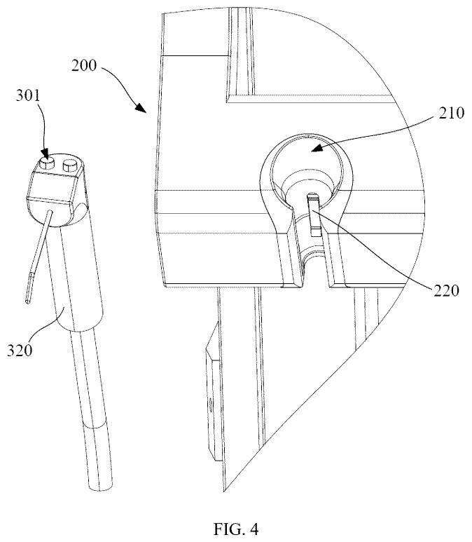

As shown in FIG. 4, each hanging portion 210 is provided with a hanging state detector 220, and the hanging state detector 220 is configured to detect whether the output terminal 300 is away from the hanging portion 210. The hanging state detector 220 can be a contact switch, an infrared sensor, and the like.

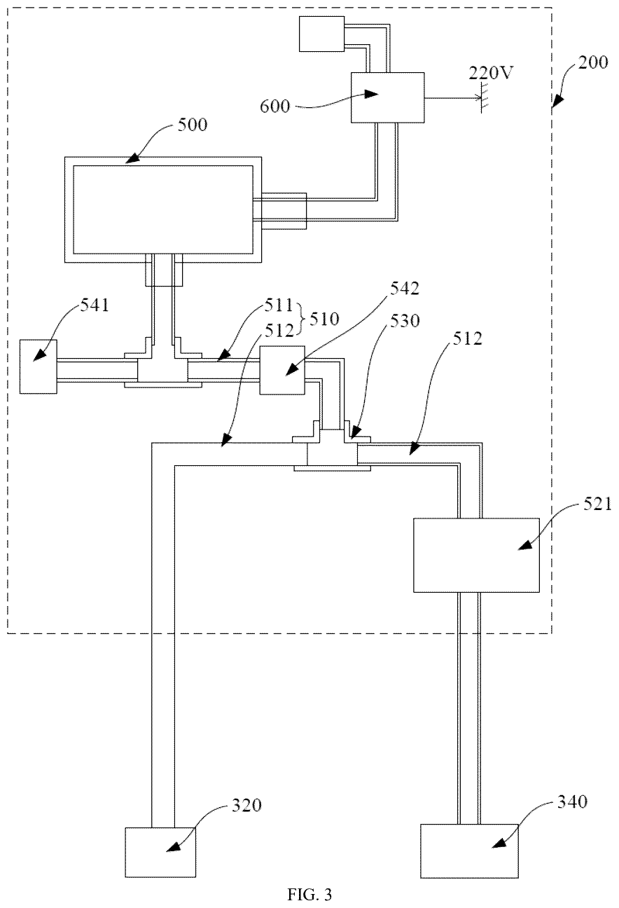

The workbench body 200 is further provided with a gas pipe set 510 and a gas valve assembly connected in series in the gas pipe set 510, and the two ends of the gas pipe set 510 communicate with the gas container 500 and the output terminal 300 respectively. It can be understood that the gas pipe set 510 may include one gas pipe or at least two gas pipes, and the gas valve assembly may correspondingly include one or at least two gas valve bodies such as solenoid valves. For example, as shown in FIG. 3, the gas pipe set 510 includes a main gas pipe 511 and at least two branch gas pipes 512. One end of the main gas pipe 511 is connected to the gas container 500, and the other end of the main gas pipe 511 is connected to the branch gas pipe 512. The branch gas pipe 512 is connected to the output terminal 300 in a one-to-one correspondence. In this way, the gas pipe set 510 may further be provided with a gas branch connector 530. One end of the main gas pipe 511 is connected to the gas container 500, and the other end of the main gas pipe 511 is connected to the two branch gas pipes 512 through the gas branch connector 530. Of course, the gas pipe set 510 may include more other gas pipes, which are not limited in this embodiment. In addition, the gas valve assembly may include a gas channel on-off valve 521, which may be a solenoid valve, and the like.

The hanging state detector 220 is electrically connected to the signal input end of the control device, and the controllable end of the gas valve assembly is electrically connected to the signal output end of the control device. The control device is configured to establish a gas discharge channel between the output terminal 300 away from the hanging portion 210 and the gas container 500 according to the detection signal of the hanging state detector 220 and the gas valve on-off signal, so as to output compressed gas to the outside. The gas valve on-off signal can be pre-stored in the memory of the control device, and the gas valve on-off signal can also be input by the user.

For example, as shown in FIG. 3, the output terminal 300 may include a three-way gun 320 and a sandblasting gun 340. One branch gas pipe 512 is configured to connect the three-way gun 320, the other branch gas pipe 512 is configured to connect the sandblasting gun 340, and the branch gas pipe 512 connected to the sandblasting gun 340 is connected in series with the gas channel on-off valve 521. The control device stores a preset disconnection signal for disconnecting the gas channel on-off valve 521. The control device is further configured to use the preset disconnection signal as the gas valve on-off signal when the three-way gun 320 is away from the hanging portion 210, and is configured to form a gas discharge channel between the three-way gun 320 and the gas container 500 according to the preset disconnection signal. It can be understood that when the three-way gun 320 in the output terminal 300 is picked up by the user and is away from the hanging portion 210, the gas channel on-off valve 521 is set by default to disconnect the branch gas pipe 512 where it is located, and the compressed air is output from the three-way gun 320 to the outside.

Of course, the gas channel on-off valve 521 can also be electrically connected to the signal output end of the control device. Furthermore, when the sandblasting gun 340 is away from the hanging portion 210, the control device is further configured to receive a gas discharge start signal, which is used for turning on the gas channel on-off valve 521 and is used as a gas valve on-off signal. Moreover, the control device is configured to form a gas discharge channel between the sandblasting gun 340 and the gas container 500 according to the gas discharge start signal. The gas discharge start signal can be input by the user. It can be understood that when the sandblasting gun 340 in the output terminal 300 is picked up by the user and is away from the hanging portion 210, the gas channel on-off valve 521 conducts the branch gas pipe 512 where the gas channel on-off valve 521 is located according to the gas discharge start signal, and the compressed air can be output from the sandblasting gun 340 to the outside.

In this embodiment, compared with connecting the gas pipe set 510 to the pipeline gas, by setting the gas container 500, the foreign matter in the medical workbench of the present application, such as debris brought into the pipeline gas, can be reduced, and the compressed gas in the gas container 500 is more convenient to discharge and replace, which is beneficial to improve sterility of the medical workbench. The control device is configured to establish a gas discharge channel between the output terminal 300 away from the hanging portion 210 and the gas container 500 according to the detection signal of the hanging state detector 220 and the gas valve on-off signal, so as to output compressed gas to the outside. The medical workbench can simultaneously reduce the conduction time corresponding to the gas discharge channel through the hanging state detector 220 and the gas container 500, thereby improving the discharge efficiency of the compressed gas, reducing the risk of other foreign matter brought into the compressed gas during the flow process, which is conducive to improving the sterility of the medical workbench, and facilitating the rapid use and outdoor use of the medical workbench.

In some embodiments, as shown in FIG. 3, the gas pipe set 510 is provided with a gas pressure detector 541 and a pressure regulation valve 542. The gas pressure detector 541 is configured to detect the gas pressure in the gas pipe set 510, and the pressure regulation valve 542 is configured to regulate the downstream gas pressure of the gas pipe set 510. The gas pressure detector 541 is electrically connected to a signal input end of a control device, and a signal output end of the control device is electrically connected to a controllable end of the pressure regulation valve 542. The control device is configured to enable the pressure regulation valve 542 to regulate the downstream gas pressure of the gas pipe set 510 according to a gas pressure detection value of the gas pressure detector 541. The gas pressure detector 541 can be configured to detect the gas pressure in the main gas pipe 511, and the pressure regulation valve 542 can be connected in series to the main gas pipe 511 to adjust the downstream gas pressure of the main gas pipe 511.

It can be understood that, compared with the pipeline gas, the total amount of compressed gas accommodated in the gas container 500 is limited, which may result in a small amount of gas. In addition, the gas container 500 or the corresponding gas pipe may be accidentally blocked, resulting in the flow of compressed gas in the gas pipe being blocked. In this case, the control device is configured to control the pressure regulation valve 542 to adjust the downstream gas pressure of the gas pipe set 510 according to the gas pressure detection value of the gas pressure detector 541, so that the medical workbench can output compressed gas with a relatively stable pressure, which is conducive to improving the use stability of the corresponding output terminal 300.

In some embodiments, as shown in FIG. 3, the medical workbench further includes a gas compressor 600, and the compressed gas output end of the gas compressor 600 is connected to the gas inlet end of the gas container 500, so that the medical workbench can provide compressed gas for a longer period of time.

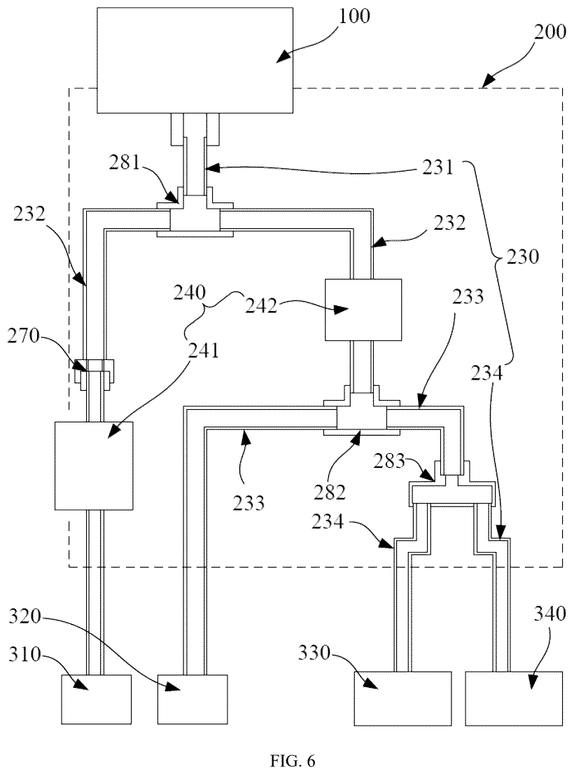

In some embodiments, as shown in FIG. 1, the medical workbench further includes a liquid container 100, which is connected to the workbench body 200. The liquid container 100 is configured to accommodate dental liquid. The dental liquid can be clean water or saline solution required for operations such as implanting teeth and cleaning teeth. As shown in FIG. 6, the workbench body 200 is further provided with a liquid pipe set 230 and a liquid valve assembly connected in series in the liquid pipe set 230. The two ends of the liquid pipe set 230 are connected to the liquid container 100 and the output terminal 300 respectively. The liquid pipe set 230 is connected to a pump assembly 240. It can be understood that the liquid pipe set 230 can include one pipeline or at least two pipelines, and the pump assembly 240 can correspondingly include one or at least two pump bodies.

The control device is further configured to receive a liquid discharge start signal input by a user, for example, the liquid discharge start signal input by a user can be received by a start device such as an operating switch or a touch panel.

The controllable end of the liquid valve assembly and the controllable end of the pump assembly 240 are electrically connected to the signal output end of the control device respectively. The control device is further configured to establish a liquid discharge channel between the corresponding output terminal 300 and the liquid container 100 through the liquid valve assembly and the liquid pipe set 230 when the hanging state detector 220 detects that the output terminal 300 is away from the hanging portion 210. For example, when the power connector 310 in the output terminal 300 is picked up by the user and is away from the hanging portion 210, the control device establishes a liquid discharge channel between the power connector 310 and the liquid container 100 through the liquid valve assembly and the liquid pipe set 230.

The control device is further configured to start the pump assembly 240 to deliver the dental liquid in the established liquid discharge channel when receiving the liquid discharge start signal. For example, after the power connector 310 is lifted and away from the hanging portion 210, if the liquid discharge start signal is received again, the control device starts the pump body corresponding to the pump assembly 240 which is arranged at the liquid discharge channel between the power connector 310 and the liquid container 100. Finally, the power connector 310 delivers the dental liquid to the outside, for example, to the oral cavity of the dental patient, so as to facilitate the operation of implantation. This principle can be applied to the situation when the three-way gun 320, the ultrasonic tooth cleaner 330 and the sandblasting gun 340 are lifted and away from the hanging portion 210, which will not be repeated here.

In this embodiment, compared with connecting the liquid pipe set 230 to the pipeline water, the medical workbench of the present application can reduce foreign matter such as rust introduced into the pipeline water by setting the liquid container 100, and the dental liquid in the liquid container 100 is easier to sterilize, which is beneficial to improving sterility of the medical workbench. The control device is configured to establish a liquid discharge channel between the corresponding output terminal 300 and the liquid container 100 through the liquid valve assembly and the liquid pipe set 230 when the hanging state detector 220 detects that the output terminal 300 is away from the hanging portion 210. The control device is further configured to start the pump assembly 240 to transport the dental liquid in the established liquid discharge channel when receiving the liquid discharge start signal. The medical workbench can reduce the conduction time of the corresponding liquid discharge channel by setting the detector hanging state detector 220 and the liquid container 100, thereby improving efficiency of the pump assembly 240 sucking the dental liquid, reducing the risk of other foreign matter being brought into the pump assembly 240 during the suction process, which is conducive to improving sterility of the medical workbench, and is conducive to the rapid use and outdoor use of the medical workbench.

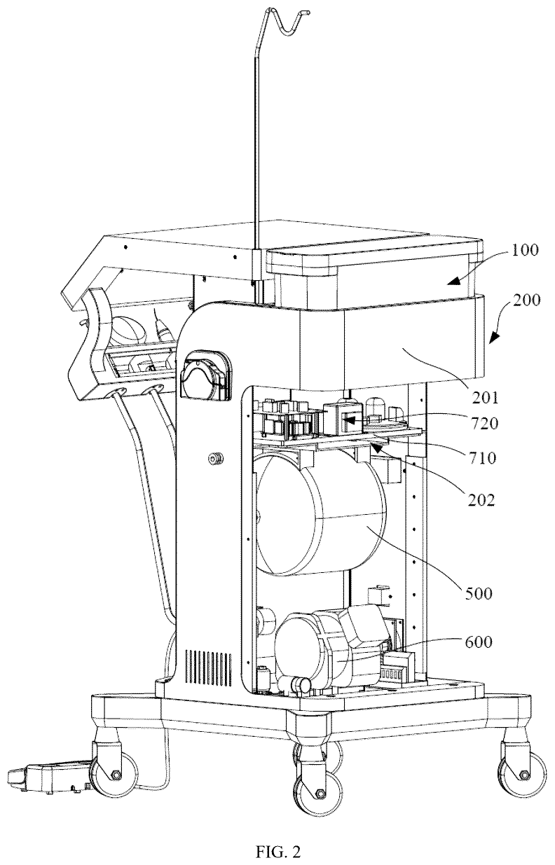

In some embodiments, as shown in FIG. 2, the control device includes a circuit board 710 and an executive device 720 mounted at the circuit board 710. The executive device 720 can be a processor or a corresponding judgment circuit, and the like. The liquid container 100, the circuit board 710, the gas container 500 and the gas compressor 600 can be arranged at the workbench body 200 from up to down, so that the circuit board 710 and the executive device 720 can have a large distance from the gas compressor 600 through the gas container 500, thereby reducing signal interference of the gas compressor 600 to the executive device 720, improving the operation stability of the control device. In addition, the gas compressor 600 is usually heavy, so that it can lower the center of gravity of the medical workbench, and it is convenient to place the liquid container 100 at a higher place for user operation.

In some embodiments, as shown in FIG. 2, the workbench body 200 includes a workbench shell 201. The liquid container 100 is installed at the upper end of the outer side of the workbench shell 201. The circuit board 710, the gas container 500 and the gas compressor 600 are respectively arranged in the workbench shell 201, thereby reducing the possibility of intrusion of foreign objects from the outside.

In some embodiments, as shown in FIG. 2, a partition plate 202 is arranged in the workbench shell 201, the circuit board 710 is installed at the upper side of the partition plate 202, and the gas container 500 is installed at the lower side of the partition plate 202. In this embodiment, the partition plate 202 can not only provide installation convenience for the circuit board 710 and the gas container 500, but also increase the structural lightness of the workbench shell 201. In addition, the gas compressor 600 can be installed at the bottom of the inner side of the workbench shell 201.

The present application further proposes a dental operation device, which includes an output terminal 300 and the medical workbench as mentioned above. The output terminal 300 includes at least two of a power connector 310, a three-way gun 320, an ultrasonic tooth cleaner 330 and a sandblasting gun 340. For example, the output terminal 300 includes a power connector 310, a three-way gun 320, an ultrasonic tooth cleaner 330 and a sandblasting gun 340.

For the three-way gun 320 of the output terminal 300, the medical workbench further includes a start device. As shown in FIG. 4, the start device includes a switch assembly 301 arranged at the three-way gun 320. The switch assembly 301 includes a gas channel switch and a liquid channel switch. The gas channel switch is configured to connect or close the gas discharge channel corresponding to the three-way gun 320 with the outside, and the gas channel switch can be configured as a mechanical switch or an electric switch. The liquid channel switch is configured to connect or close the liquid discharge channel corresponding to the three-way gun 320 with the outside, and the liquid channel switch has a signal output end electrically connected to the controllable end of the pump assembly 240. In this case, the control device is configured to, when the hanging state detector 220 detects that the three-way gun 320 is away from the hanging portion 210, establish a gas discharge channel between the three-way gun 320 and the gas container 500 through the gas channel switch or receive a liquid discharge start signal input by the user through the liquid channel switch, thereby reducing the possibility that the three-way gun 320 is interfered by other output terminals 300 when in use.

For the sandblasting gun 340 of the output terminal 300, the start device includes a foot pedal device 400 separably provided with the output terminal 300. The gas channel on-off valve 521 is connected in series to the gas discharge channel corresponding to the sandblasting gun 340, and the liquid channel on-off valve (such as a solenoid valve) is connected in series to the liquid discharge channel corresponding to the sandblasting gun 340. The control device is configured to receive the gas valve on-off signal or the liquid discharge start signal input by the user through the foot pedal device 400 when the hanging state detector 220 detects that the sandblasting gun 340 is away from the hanging portion 210, thereby reducing the possibility that the sandblasting gun 340 is interfered by other output terminals 300 when in use.

In some embodiments, as shown in FIG. 6, the liquid pipe set 230 includes a main pipe 232 and at least two branch pipes 233. One end of the main pipe 232 is connected to the liquid container 100, and the other end of the main pipe 232 is connected to the branch pipe 233. The main pipe 232 can be directly connected to the liquid container 100. Of course, the main pipe 232 can also be indirectly connected to the liquid container 100 through other pipe structures, for example, the main pipe 232 is indirectly connected to the liquid container 100 through the common pipe 231 in the figure.

The pump assembly 240 is connected to the main pipe 232. For example, the pump assembly 240 may include a peristaltic pump 241 and a serial pump 242. The liquid pipe set 230 may include two main pipes 232 arranged in parallel. One main pipe 232 is serially connected with a serial pump 242, and the peristaltic pump 241 is arranged in cooperation with the other main pipe 232, so that the main pipe 232 transports dental liquid. Compared with the peristaltic pump 241, the serial pump 242 can be configured as a pump body that allows dental liquid to flow through it. Correspondingly, the serial pump 242 is connected in series with the main pipe 232, which means that after the serial pump 242 is connected to the main pipe 232, the serial pump 242 and the main pipe 232 form a passage together.

In this embodiment, the pump assembly 240 is connected to the main pipe 232, which is conducive to reducing the number of pump assemblies 240, and is conducive to reducing the overall parts cost of the medical workbench.

In some embodiments, as shown in FIG. 1, the workbench body 200 is further provided with an adjustment device 260, which is electrically connected to the signal input end of the control device. The adjustment device 260 is configured to receive the adjustment signal input by the user, and the pump assembly 240 is configured to adjust the rotation speed according to the adjustment signal. The adjustment device 260 is configured to start and receive the adjustment signal when the control device receives the liquid discharge start signal. The adjustment device 260 can be configured as a touch panel, an operation panel with buttons, an operation knob or an operation rod, and the like. In this embodiment, the pump assembly 240 can adjust the rotation speed according to the adjustment signal, which is conducive to making the flow rate of the dental liquid output to the outside closer to the actual demand, thereby reducing waste of the dental liquid. In addition, the adjustment device 260 is configured to start and receive the adjustment signal when the control device receives the liquid discharge start signal, thereby reducing the opening time of the adjustment device 260 and reducing the risk of the adjustment device 260 being operated by mistake.

In some embodiments, as shown in FIG. 6, among the two parallel main pipes 232 of the liquid pipe set 230, one main pipe 232 is configured to connect the power connector 310. This means that the power connector 310 can transport the dental liquid through the main pipe 232, which is conducive to reducing the pressure loss caused by the pipeline branch to the power connector 310, and is conducive to increasing the flow rate of the dental liquid output by the power connector 310.

In some embodiments, as shown in FIG. 6, a detachable connector 270 is connected in series with the main pipe 232 connected to the power connector 310. It can be understood that the detachable connector 270 can form a passage together with the main pipe 232. The detachable connector 270 is arranged at the upstream of the peristaltic pump 241 along the liquid delivery direction, and the detachable connector 270 can be set in the form of a male and female plug.

In this embodiment, the main pipe 232 where the power connector 310 is located can be connected to an external liquid source of dental liquid, such as piped water, by disassembling the detachable connector 270, thereby improving the use convenience of the medical workbench and the adaptability degree to different use occasions.

In some embodiments, as shown in FIG. 6, the liquid pipe set 230 is provided with a first flow distribution connector 281 and a second flow distribution connector 282. The liquid valve assembly can include a flow distribution valve 283. The liquid pipe set 230 can further include the above-mentioned common pipe 231. One end of the common pipe 231 is connected to the liquid container 100. The other end of the common pipe 231 is respectively connected to two main pipes 232 through the first flow distribution connector 281. The two branch pipes 233 are connected to the main pipe 232 connected in series with the serial pump 242 through the second flow distribution connector 282. For example, the two branch pipes 233 are connected to the main pipe 232 at the right side of FIG. 6 through the second flow distribution connector 282. At least one branch pipe 233 is connected to two branch sub-pipes 234 through a distribution valve 283. For example, the branch pipe 233 at the right side of FIG. 6 is connected to two branch sub-pipes 234 through a distribution valve 283.

In this embodiment, the medical workbench can form a pipeline structure with different branch levels, so as to be more convenient to adapt to the output terminal 300 with different flow requirements. For example, the first main pipe 232 is directly connected to the power connector 310 without forming any branches, and the second main pipe 232 is connected to the three-way gun 320 after passing through the first branch pipe 233 without forming any other additional branches. The second main pipe 232 is connected to the ultrasonic tooth cleaner 330 after passing through the second branch pipe 233 and the first branch sub-pipe 234, and the second main pipe 232 is connected to the sandblasting gun 340 after passing through the second branch pipe 233 and the second branch sub-pipe 234, thereby forming a pipeline structure with different branch levels. In addition, the two branch pipes 233 are connected to the main pipe 232 connected in series with the serial pump 242 through the second distribution connector 282, so that the serial pump 242 can provide pumping force for the liquid discharge channel formed by different output terminals 300, which is conducive to reducing the number of serial pumps 242 and reducing costs.

In some embodiments, the distribution valve 283 is configured as a three-position two-way solenoid valve including a cut-off position and two conduction positions. The three-position two-way solenoid valve can be a distribution valve having two conduction positions (i.e., two conduction working states) and two external output interfaces. The distribution valve 283 is electrically connected to the signal output end of the control device. The control device is further configured to control the conduction position of the distribution valve 283 according to the output signal of the hanging state detector 220 and control the peristaltic pump 241 to start and stop, and control the serial pump 242 to start and stop according to the liquid discharge start signal, so that a liquid discharge channel is formed between each output terminal 300 and the liquid container 100.

In this embodiment, the medical workbench can control the conduction position of the distribution valve 283 and control the start and stop of the peristaltic pump 241 and the start and stop of the serial pump 242 through the control device, thereby reducing the possibility of the dental liquid accidentally flowing into other pipelines where a liquid discharge channel is not formed, and reducing the risk of accidental leakage of the dental liquid. For example, in FIG. 6, when the sandblasting gun 340 needs to output dental liquid, the peristaltic pump 241 corresponding to the left output interface of the first distribution connector 281 stops and the right output interface is turned on, the valve at the three-way gun 320 corresponding to the left output interface of the second distribution connector 282 is closed and the right output interface is turned on, and the left output interface of the distribution valve 283 is closed and the right output interface is turned on, which can reduce the risk of dental liquid accidentally flowing into the power connector 310 and the pipeline thereof, the three-way gun 320 and the pipeline thereof, and the ultrasonic tooth cleaner 330 and the pipeline thereof.

The liquid channel on-off valve can be configured as the above-mentioned distribution valve 283.

In addition, the control device is further configured to receive the liquid discharge start signal input by the user through the foot pedal device 400 when the hanging state detector 220 detects that the ultrasonic tooth cleaner 330 is away from the hanging portion 210, thereby reducing the possibility that the ultrasonic tooth cleaner 330 is interfered with by other output terminals 300 when in use.

In addition, the control device is further configured to receive the liquid discharge start signal input by the user through the foot pedal device 400 when the hanging state detector 220 detects that the power connector 310 is away from the hanging portion 210, thereby reducing the possibility that the power connector 310 is interfered with by other output terminals 300 when in use.

In some embodiments, as shown in FIG. 1, the workbench body 200 is provided with an information output device 250, and the information output device 250 is electrically connected to the signal output end of the control device. The control device is further configured to make the information output device 250 output a first preset prompt message and/or make the pump assembly 240 stop pumping the dental liquid when at least two hanging state detectors 220 detect that the corresponding output terminal 300 is away from the hanging portion 210. The information output device 250 can be configured as a display panel, a speaker or a display light.

Usually, only one output terminal 300 needs to be picked up in operations such as implantation and cleaning. When two or more output terminals 300 are away from the hanging portion 210 at the same time, usually some of the output terminals 300 fall abnormally. In this embodiment, the medical workbench can output a first preset prompt message and/or make the pump assembly 240 stop pumping the dental liquid, which is beneficial to reducing waste of the dental liquid caused by the abnormal drop of the output terminal 300.

In some embodiments, the workbench body 200 is provided with a plurality of preset marks, which can be configured as icons, lamp bodies displaying different preset colors, and the like. The preset marks are set in a one-to-one correspondence with the hanging portion 210, and the preset marks corresponding to different hanging portions 210 have different preset forms, which can be understood that the preset marks corresponding to different hanging portions 210 have different shapes or states.

In this embodiment, the preset marks can remind the user and prevent the user from taking or hanging the wrong output terminal 300, which is beneficial to improving the use efficiency of the medical workbench.

In some embodiments, the pump assembly 240 is configured as an electric pump, and the workbench body 200 is further provided with a current detector, which is configured to detect the driving current of the pump assembly 240, and the signal output end of the current detector is electrically connected to the control device. The signal output end of the control device is electrically connected to the information output device 250 as mentioned above. The control device is further configured to make the information output device 250 output a second preset prompt message and/or make the pump assembly 240 stop pumping the dental liquid, when the detection value of the current detector is greater than or equal to a preset upper limit, or when the detection value of the current detector is less than or equal to a preset lower limit.

It can be understandable that, compared with pipeline liquids such as pipeline water, the total amount of dental liquid accommodated in liquid container 100 is limited, which may lead to liquid shortage. In addition, liquid container 100 may also be accidentally sealed, resulting in difficulty in the flow of dental liquid in the pipeline and blockage. In this embodiment, when liquid shortage occurs, the pump assembly 240 may become idling, and the driving current of pump assembly 240 detected by the current detection device is less than the preset lower limit value. In this case, the problem of liquid shortage can be solved as soon as possible by outputting a second preset prompt message and/or making the pump assembly 240 stop pumping dental liquid. When liquid blockage occurs, the driving current of the pump assembly 240 detected by the current detection device is greater than the preset lower limit value. In this case, the liquid blockage problem can be solved as soon as possible by outputting the second preset prompt message and/or making the pump assembly 240 stop pumping the dental liquid.

In some embodiments, as shown in FIG. 1, the medical workbench further includes a start device. The start device includes a foot pedal device 400 separably provided with the output terminal 300, and/or the start device includes a switch assembly 301 provided at the output terminal 300. For at least one output terminal 300, the control device receives the liquid discharge start signal input by the user through the foot pedal device 400 or the switch assembly 301, thereby reducing the risk of performing operation by mistake. For example, when the control device receives the liquid discharge start signal input by the user through the foot pedal device 400, the control device shields the signal from the switch assembly 301. Or, when the control device receives the liquid discharge start signal input by the user through the switch assembly 301, the control device shields the signal from the foot pedal device 400.

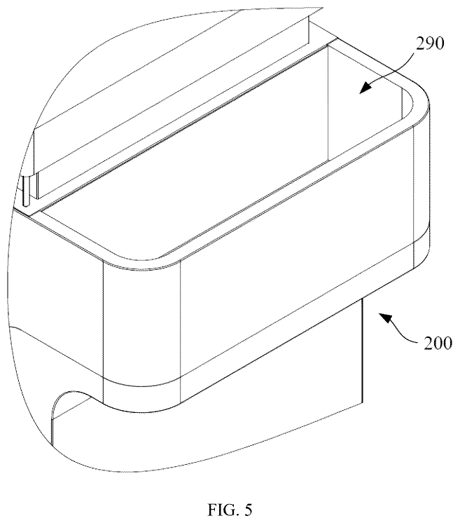

In some embodiments, as shown in FIG. 1 and FIG. 5, an accommodation groove 290 is provided at the top of the workbench body 200, and part of the liquid container 100 is accommodated in the accommodation groove 290. The liquid container 100 is detachably connected to the workbench body 200 The pipelines of the liquid container 100 can be connected to the workbench body 200 through a detachable connector. The outer side of the liquid container 100 is provided with a grip boss 110. A height gap can be formed between the grip boss 110 and the top of the accommodation groove 290.

In this embodiment, the height gap formed between the grip boss 110 and the top of the accommodation groove 290 facilitates the user to put his hands in, improves the convenience of the user to disassemble and assemble the liquid container 100, and is conducive to increasing the capacity of the liquid container 100 to accommodate more dental liquid.

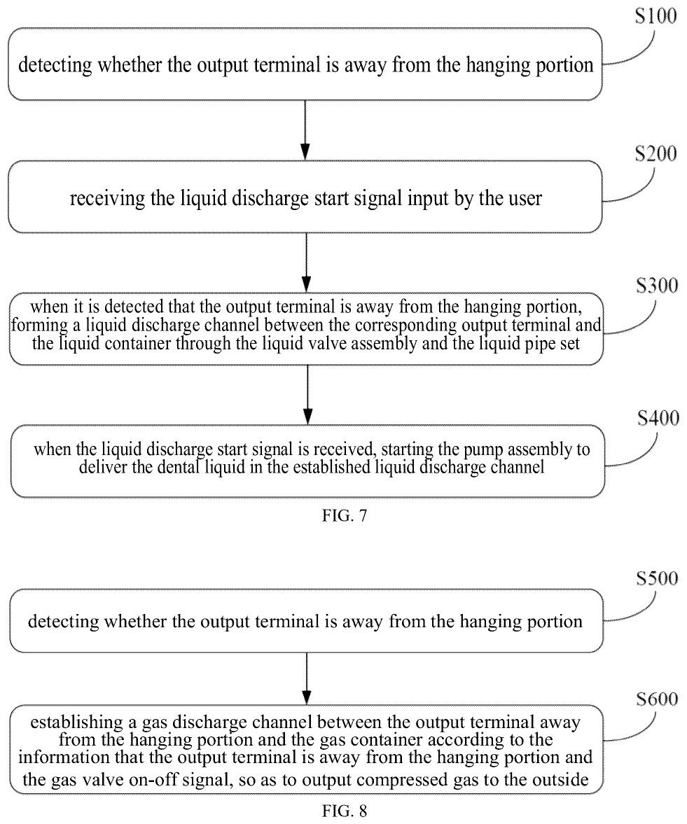

As shown in FIG. 7, the present application proposes a method for controlling a medical workbench, which is applied to the above-mentioned medical workbench, and the method includes the following steps.
Step S100, detecting whether the output terminal 300 is away from the hanging portion 210. For example, detection is performed by the above-mentioned hanging state detector 220 at the hanging portion 210.
Step S200, receiving the liquid discharge start signal input by the user. For example, receiving the liquid discharge start signal input by the user through the above-mentioned control device.
Step S300, when it is detected that the output terminal 300 is away from the hanging portion 210, forming a liquid discharge channel between the corresponding output terminal 300 and the liquid container 100 through the liquid valve assembly and the liquid pipe set 230.
Step S400, when the liquid discharge start signal is received, starting the pump assembly 240 to deliver the dental liquid in the established liquid discharge channel.

In addition, the method may further include the following steps: when it is detected that at least two output terminals 300 are away from the hanging portion 210, a first preset prompt message is output and/or the pump assembly 240 stops pumping the dental liquid.

In addition, as shown in FIG. 8, the present application further proposes a method for controlling a medical workbench, which is applied to the above-mentioned medical workbench, and the method includes the following steps.
Step S500, detecting whether the output terminal 300 is away from the hanging portion 210. For example, detection is performed by the above-mentioned hanging state detector 220 disposed at the hanging portion 210.
Step S600, establishing a gas discharge channel between the output terminal 300 away from the hanging portion 210 and the gas container 500 according to the information that the output terminal 300 is away from the hanging portion 210 and the gas valve on-off signal, so as to output compressed gas to the outside.

It can be understood that the method for controlling the medical workbench in the two embodiments as mentioned above can be used in combination, and each step can be performed in parallel or serial according to actual needs.

It should be noted that since the dental operation device and the method for controlling the medical workbench directly adopt or correspond to all the technical solutions of all the above embodiments, they at least include all the beneficial effects brought by the technical solutions of the above embodiments, which will not be repeated here.

The above are only some embodiments of the present application, and do not limit the scope of the present application thereto. Under the concept of the present application, any equivalent structural transformation made according to the description and drawings of the present application, or direct/indirect application in other related technical fields, shall fall within the scope of the present application.

What is claimed is:

1. A medical workbench, comprising:
a gas container;
a workbench body; and
a control device, wherein:
the gas container is connected to the workbench body and is configured to accommodate compressed gas;
the workbench body is provided with at least two hanging portions, and an output terminal is configured to be hung at one hanging portion;
each hanging portion is provided with a hanging state detector, and the hanging state detector is configured to detect whether the output terminal is far away from the hanging portion;
the workbench body is further provided with a gas pipe set and a gas valve assembly connected in series in the gas pipe set;
one end of the gas pipe set is connected to the gas container, and the other end of the gas pipe set is connected to the output terminal;
the hanging state detector is electrically connected to a signal input end of the control device, and a controllable end of the gas valve assembly is electrically connected to a signal output end of the control device; and
the control device is configured to establish a gas discharge channel between the output terminal far away from the hanging portion and the gas container according to a detection signal of the hanging state detector and a gas valve on-off signal, to output the compressed gas to outside.

2. The medical workbench according to claim 1, wherein the gas pipe set comprises a main gas pipe and at least two branch gas pipes; one end of the main gas pipe is communicated with the gas container, and the other end of the main gas pipe is communicated with the branch gas pipe; the branch gas pipe is communicated with the output terminal in a one-to-one correspondence.

3. The medical workbench according to claim 2, wherein:
the output terminal comprises a three-way gun and a sandblasting gun;
the gas pipe set is provided with a gas branch connector, and the gas valve assembly comprises a gas channel on-off valve; one end of the main gas pipe is communicated with the gas container, and the other end of the main gas pipe is communicated with two branch gas pipes through the gas branch connector; one branch gas pipe is connected to the three-way gun, and the other branch gas pipe is connected to the sandblasting gun; the gas channel on-off valve is connected in series to the branch gas pipe of the sandblasting gun;
the control device stores a preset disconnection signal for disconnecting the gas channel on-off valve, and the control device is further configured to use the preset disconnection signal as the gas valve on-off signal in response to that the three-way gun is away from the hanging portion, to form the gas discharge channel between the three-way gun and the gas container according to the preset disconnection signal; and
the gas channel on-off valve is electrically connected to the signal output end of the control device, and the control device is further configured to receive a gas discharge start signal configured to turn on the gas channel on-off valve as the gas valve on-off signal in response to that the sandblasting gun is away from the hanging portion, to form the gas discharge channel between the sandblasting gun and the gas container according to the gas discharge start signal.

4. The medical workbench according to claim 2, wherein:
the gas pipe set is provided with a gas pressure detector and a pressure regulation valve; the gas pressure detector is configured to detect a gas pressure in the gas pipe set, and the pressure regulation valve is configured to regulate a downstream gas pressure of the gas pipe set;
the gas pressure detector is electrically connected to the signal input end of the control device, and the signal output end of the control device is electrically connected to a controllable end of the pressure regulation valve; the control device is configured to make the pressure regulation valve adjust the downstream gas pressure of the gas pipe set according to a gas pressure detection value of the gas pressure detector; and
the gas pressure detector is configured to detect a gas pressure in the main gas pipe, and the pressure regulation valve is connected in series to the main gas pipe to adjust a downstream gas pressure of the main gas pipe.

5. The medical workbench according to claim 1, further comprising:
a gas compressor; and
a liquid container, wherein:
a compressed gas output end of the gas compressor is connected to a gas inlet end of the gas container;
the liquid container is connected to the workbench body, and the liquid container is configured to accommodate dental liquid; the workbench body is further provided with a liquid pipe set and a liquid valve assembly connected in series in the liquid pipe set; one end of the liquid pipe set is communicated with the liquid container, and the other end of the liquid pipe set is communicated with the output terminal; the liquid pipe set is connected to a pump assembly;
the control device is further configured to receive a liquid discharge start signal input by a user; a controllable end of the liquid valve assembly is electrically connected to the signal output end of the control device, and a controllable end of the pump assembly is electrically connected to the signal output end of the control device;
the control device is further configured to establish a liquid discharge channel between an output terminal and the liquid container through the liquid valve assembly and the liquid pipe set in response to that the hanging state detector detects that the output terminal is away from the hanging portion; and
the control device is further configured to start the pump assembly and deliver the dental liquid in an established liquid discharge channel in response to receiving the liquid discharge start signal.

6. The medical workbench according to claim 5, wherein:
the control device comprises a circuit board and an executive device mounted at the circuit board;
the liquid container, the circuit board, the gas container and the gas compressor are arranged at the workbench body from up to down;
the workbench body comprises a workbench shell; the liquid container is mounted at an upper end of an outer side of the workbench shell, and the circuit board, the gas container and the gas compressor are arranged in the workbench shell; and
a partition plate is provided in the workbench shell, and the circuit board is mounted at an upper side of the partition plate; the gas container is mounted at a lower side of the partition plate, and the gas compressor is mounted at a bottom end of an inner side of the workbench shell.

7. The medical workbench according to claim 5, wherein:
the workbench body is provided with an information output device, and the information output device is electrically connected to the signal output end of the control device; and
the control device is further configured to make the information output device output a first preset prompt message and/or make the pump assembly stop pumping dental liquid in response to that at least two of the hanging state detectors detect that the corresponding output terminal is away from the hanging portion.

8. The medical workbench according to claim 7, wherein the workbench body is provided with a plurality of preset marks; the preset marks correspond to the hanging portion one by one, and the preset marks corresponding to different hanging portions comprise different preset forms.

9. The medical workbench according to claim 7, wherein the liquid pipe set comprises a main pipe and at least two branch pipes; one end of the main pipe is communicated with the liquid container, and the other end of the main pipe is communicated with the branch pipe; the pump assembly is connected to the main pipe.

10. The medical workbench according to claim 9, wherein:
the workbench body is further provided with an adjustment device, and the adjustment device is electrically connected to the signal input end of the control device; the adjustment device is configured to receive an adjustment signal input by a user, and the pump assembly is configured to adjust a rotation speed according to the adjustment signal; and
the adjustment device is configured to start and receive the adjustment signal in response to that the control device receives the liquid discharge start signal.

11. The medical workbench according to claim 9, wherein the pump assembly comprises a peristaltic pump and a serial pump, and the output terminal comprises a power connector; the liquid pipe set comprises two parallel main pipes; one main pipe is connected in series with the serial pump, and the other main pipe is configured to connect to the power connector; the peristaltic pump is arranged in cooperation with the main pipe connected to the power connector, to make the main pipe transport the dental liquid.

12. The medical workbench according to claim 11, wherein:
a detachable connector is serially connected to the main pipe connected to the power connector, and the detachable connector is arranged at an upstream end of the peristaltic pump in a liquid delivery direction; and/or
the liquid pipe set is provided with a first distribution connector and a second distribution connector; the valve assembly comprises a distribution valve, and the liquid pipe set further comprises a common pipe; one end of the common pipe is communicated with the liquid container, and the other end of the common pipe is connected to two main pipes through the first distribution connector; two branch pipes are connected to the main pipe serially connected to the serial pump through the second distribution connector, and at least one branch pipe is connected to two branch sub-pipes through the distribution valve; the distribution valve is configured as a three-position two-way solenoid valve comprising a cut-off position and two conduction positions; the distribution valve is electrically connected to the signal output end of the control device, and the control device is further configured to control each conduction position of the distribution valve according to an output signal of the hanging state detector and control the peristaltic pump to start and stop and the serial pump to start and stop according to the liquid discharge start signal, to form the liquid discharge channel between each output terminal and the liquid container.

13. The medical workbench according to claim 1, wherein:
the pump assembly is configured as an electric pump, and the workbench body is further provided with a current detector and an information output device; the current detector is configured to detect a driving current of the pump assembly; the signal output end of the current detector is electrically connected to the control device, and the signal output end of the control device is electrically connected to the information output device;
in response to that a detection value of the current detector is greater than or equal to a preset upper limit value or the detection value of the current detector is less than or equal to a preset lower limit value, the control device is further configured to make the information output device output a second preset prompt message and/or make the pump assembly stop pumping the dental liquid; and/or
an accommodation groove is provided at a top of the workbench body; part of the liquid container is accommodated in the accommodation groove, and the liquid container is detachably connected to the workbench body; a grip boss is provided at an outer side of the liquid container, and a height gap is formed between the grip boss and the top of the accommodation groove; and/or
the medical workbench further comprises a start device, and the start device comprises a foot pedal device separately arranged with the output terminal and/or the start device comprises a switch assembly provided at the output terminal; for at least one of the output terminals, the control device is configured to receive the liquid discharge start signal input by a user through the foot pedal device or through the switch assembly.

14. A dental operation device, comprising:
an output terminal; and
the medical workbench according to claim 1;
wherein the output terminal comprises at least two of a power connector, a three-way gun, an ultrasonic tooth cleaner and a sandblasting gun.

15. A dental operation device, comprising:
an output terminal; and
the medical workbench according to claim 5, wherein:
the output terminal comprises a three-way gun, and the medical workbench further comprises a start device;
the start device comprises a switch assembly provided at the three-way gun;
the switch assembly comprises a gas channel switch and a liquid channel switch; the gas channel switch is configured to cause the gas discharge channel corresponding to the three-way gun to be connected to an outside world or closed with the outside world, and the liquid channel switch is configured to cause the liquid discharge channel corresponding to the three-way gun to be connected to the outside world or closed with the outside world; the liquid channel switch is provided with a signal output end electrically connected to the controllable end of the pump assembly; and
in response to that the hanging state detector detects that the three-way gun is away from the hanging portion, the control device is configured to establish a gas discharge channel between the three-way gun and the gas container through the gas channel switch, or receive the liquid discharge start signal input by a user through the liquid channel switch.

16. The dental operation device according to claim 15, wherein:
the output terminal comprises a sandblasting gun, and the start device comprises a foot pedal device separately arranged with the output terminal; a gas channel on-off valve is connected in series in the gas discharge channel corresponding to the sandblasting gun, and a liquid channel on-off valve is connected in series in the liquid discharge channel corresponding to the sandblasting gun;
in response to that the hanging state detector detects that the sandblasting gun is away from the hanging portion, the control device is configured to receive the gas valve on-off signal or the liquid discharge start signal input by the user through the foot pedal device;
the liquid pipe set comprises a main pipe and at least two branch pipes; one end of the main pipe is communicated with the liquid container, and the other end of the main pipe is communicated with the branch pipe; the pump assembly is connected to the main pipe;
the pump assembly comprises a peristaltic pump and a serial pump, and the output terminal further comprises a power connector; the liquid pipe set comprises two parallel main pipes; the serial pump is connected in series to one main pipe, and the power connector is connected to the other main pipe; the peristaltic pump is arranged in cooperation with the main pipe connected to the power connector, to make the main pipe transport dental liquid;
the liquid pipe set is provided with a first distribution connector and a second distribution connector; the liquid valve assembly comprises a distribution valve, and the liquid pipe set further comprises a common pipe; one end of the common pipe is communicated with the liquid container, and the other end of the common pipe is connected to the two main pipes through the first distribution connector;
the two branch pipes are connected to the main pipe connected in series with the serial pump through the second distribution connector, and at least one branch pipe is connected to two branch sub-pipes through the distribution valve; the distribution valve is configured as a three-position two-way solenoid valve comprising a cut-off position and two conduction positions, and the distribution valve is electrically connected to the signal output end of the control device; the control device is further configured to control a conduction position of the distribution valve according to the output signal of the hanging state detector and control the peristaltic pump to start and stop and the serial pump to start and stop according to the liquid discharge start signal, to make the liquid discharge channel formed between each output terminal and the liquid container;
the liquid channel on-off valve is configured as the distribution valve, and the output terminal further comprises an ultrasonic tooth cleaner; the ultrasonic tooth cleaner and the sandblasting gun are connected to the two branch sub-pipes one by one;
in response to that the hanging state detector detects that the ultrasonic tooth cleaner is away from the hanging portion, the control device is further configured to receive the liquid discharge start signal input by the user through the foot pedal; and
in response to that the hanging state detector detects that the power connector is away from the hanging portion, the control device is further configured to receive the liquid discharge start signal input by the user through the foot pedal.

17. A method for controlling a medical workbench, applied to the medical workbench according to claim 1, wherein the method comprises:
detecting whether the output terminal is away from the hanging portion; and
establishing a gas discharge channel between the output terminal away from the hanging portion and the gas container according to information that the output terminal is away from the hanging portion and the gas valve on-off signal, to output compressed gas to outside.
